(19) United States
(12) Patent Application Publication
(10) Pub. No.: US 2008/0033961 A1
(43) Pub. Date: Feb. 7, 2008

(54) Electronic Document Browsing

(75) Inventors: Tommy Berglund, Johanneshou (SE); Fredrik Abelsson, Stockholm (SE); Hans Bjurstrom, Stockholm (SE)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 11/631,332

(22) PCT Filed: Jun. 30, 2005
(86) PCT No.: PCT/EP05/53103

§ 371 Date: Jul. 30, 2007

(30) Foreign Application Priority Data
Jul. 2, 2004 (GB) 0414857.3

(51) Int. Cl. G06F 17/30

(52) U.S. Cl. 707/10; 707/E17.008

(57) ABSTRACT

According to an aspect of the present invention, there is provided a method of operating a browser, the browser operable for accessing electronic documents accessible via a document server, at least some of the electronic documents having associated therewith a data package intended for storage by the browser, comprising: receiving from the document server an electronic document and a data package; obtaining the identity of a data store; and sending the data package to the identified data store for storage therein.

The present invention relates generally to the field of electronic document browsing, such as the browsing of information pages supplied by a document server, using a document browser.

The use of electronic document browser software applications (hereinafter referred to generally as browsers) for enabling computer users to access or browse electronic documents, such as web pages, is commonplace.

Internet browsing, a term used when electronic documents are accessed over Internet protocol (IP) networks using a browser, is typically achieved using a request-response mechanism known as the hypertext transfer protocol (HTTP). Using HTTP a browser sends a HTTP request to a document server, such as a web server, the address of which is indicated by a universal resource indicator (URI) contained in the request. The URI, in addition to identifying the address of a web server also identifies a web page located on the web server. Upon receiving the request, the web server responds (if indeed the identified web page is located on the web server) by sending the requested page, typically encoded in hypertext mark-up language (HTML), back to the browser. The browser renders the received web page and displays it to the user in a generally known manner.

If the user requests a further web page, for example by activating a hyperlink embedded in the displayed web page, a new HTTP request is sent by the browser and a new response is generated by the appropriate web server. Successive HTTP requests, even from the same browser, are treated independently of one another, since HTTP does not provide for any context between requests.

To overcome the lack of context so-called cookies have been developed. A cookie is a data package generated by a web server and stored by a browser on the computing device hosting the browser. A cookie enables a web server to identify when a specific browser or user of a browser identified to the web server is accessing a web page hosted by the web server. Cookies may be used for many different reasons including enabling a web server to generate and control personalized content and for enabling a web server to track or monitor a user's browsing habits.

There are two principle types of cookies: session cookies, which are stored only whilst the browser session is active, and persistent cookies which have a defined expiration date in the future during which time they are stored in a persistent manner.

Session cookies enable, for example, a web server to track the contents of an electronic shopping basket of a specific user during a browsing session. Persistent cookies, on the other hand, enable a web server to track the contents of an electronic shopping basket, in relation to a specific user over many browsing sessions.

The management of cookies on the user-side is performed by the browser using the resources of the host computing device hosting the browser. Thus, if a browser stores a persistent cookie, that cookie is stored by the browser in a persistent storage area of the host device made available to the browser, such as a hard disk drive or flash memory. Different browsers use different techniques for storing cookies, for example, some browsers store cookies as individual files, whilst other browsers use a single text-based file to store all cookies associated with that browser.

Cookies are generally unique to a specific browser. Thus, if a user uses, on a single computing device, two different browsers to access the same web site which causes a persistent cookie to be stored, this will result in two different persistent cookies being stored. One of the problems this creates is that if a user uses two different browsers to browse the same web site, the web server will not know that the two different cookies belong to the same user.

Problems also arise in other areas, such as that of voice browsing. Voice browsing enables telephone callers to access a voice browser application through which access to the Internet may be made through a telephoned-based user interface. For example, input to a voice browser is typically made using speech recognition or DTMF tone detection, and information content retrieved over the Internet is converted to speech or audio for output to the user.

Given the high performance requirements of voice browsers, voice browsers are generally provided by a service provider and typically allow multiple callers to access to the Internet at the same time.

Since the voice browser is provided over a network, there is no user-side storage available for storing persistent cookies. Many web sites are designed to only be fully functional when the storage of persistent cookies is allowed by a browser. Thus, if no persistent cookie storage is available to a browser this may result in the inability of users of a voice browser to access, or at least unable to fully access, certain web sites.

Accordingly, one aim of the present invention is overcome, or alleviate, at least some of the above-mentioned problems.

According to a first aspect of the present invention, there is provided a method of operating a browser, the browser operable for accessing electronic documents accessible via a document server, at least some of the electronic documents having associated therewith a data package intended for storage by the browser. The method comprises receiving from the document server an electronic document and a data package, obtaining the identity of a data store, and sending the data package to the identified data store for storage therein.

Advantageously, data packages, such as cookies no longer need be associated uniquely with a particular browser or browser instance, but may be associated with a personalized storage medium. This enables, for example a user to use different browsers, and even different browsers on different computing devices, to access web pages whilst maintaining the continuity provided for by cookies.

Such a system also allows users of browsers that do not provide for the storing of persistent data packages, such as voice browsers, to browse electronic documents as if the persistent storing of data packages by the browser was provided.

The data store may be remote from the browser, in which case the step of obtaining the identity of the data store comprises obtaining the address of the data store.

The data store may be an account-based data store, in which case the step of obtaining obtains account identification information associated with the data store.

The account identification information and the identity of the data store may be obtained from configuration data in the browser.

If the browser is a voice browser accessible via a telecommunications network by way of a telephone call placed using a user terminal, the step of obtaining account identification information comprises obtaining the subscriber number of the user terminal from information supplied by the telecommunications network.

The expiry date of the received data package may be determined, and where the expiry date is in the future, the data package is sent to the identified data store, otherwise the data package is stored in a temporary data store associated with the browser.

The step of receiving a data package may comprise receiving a data package in the form of a cookie.

According to a second aspect of the present invention, there is provided a method of operating a browser, the browser operable for accessing electronic documents accessible via a document server. The method comprises acquiring an address of a requested electronic document to be retrieved, obtaining the identity of a data store, determining the presence in the identified data store of a data package associated with the requested electronic document, and where present retrieving the data package, and sending a request to receive the requested electronic document and sending the retrieved data package with the request, where present.

The data store may be remote from the browser, in which case the step of obtaining the identity of the data store comprises obtaining the address of the data store.

The data store may be an account-based data store, in which case the step of obtaining further comprises obtaining account identification information associated with the data store.

The identity and account information may be obtained from configuration data in the browser.

If the browser is a voice browser accessible via a telecommunications network by way of a telephone call placed using a user terminal, the step of obtaining account identification information may comprise obtaining the subscriber number of the user terminal from information supplied by the telecommunications network.

The expiry date of the retrieved data package may be determined, and the step of sending the data package is adapted for only sending the data package where it is determined that the data package has not expired.

The steps of sending and retrieving a data package may comprise sending and retrieving a data package in the form of a cookie.

According to a third and fourth aspect of the present invention, there is provided a browser operating in accordance with the above-mentioned method steps.

According to a fifth aspect of the present invention, there is provided a computer program comprising computer program code means to implement a browser or method as described above.

Embodiments of the present invention will now be described, by way of example only, with reference to the accompanying drawings, in which:

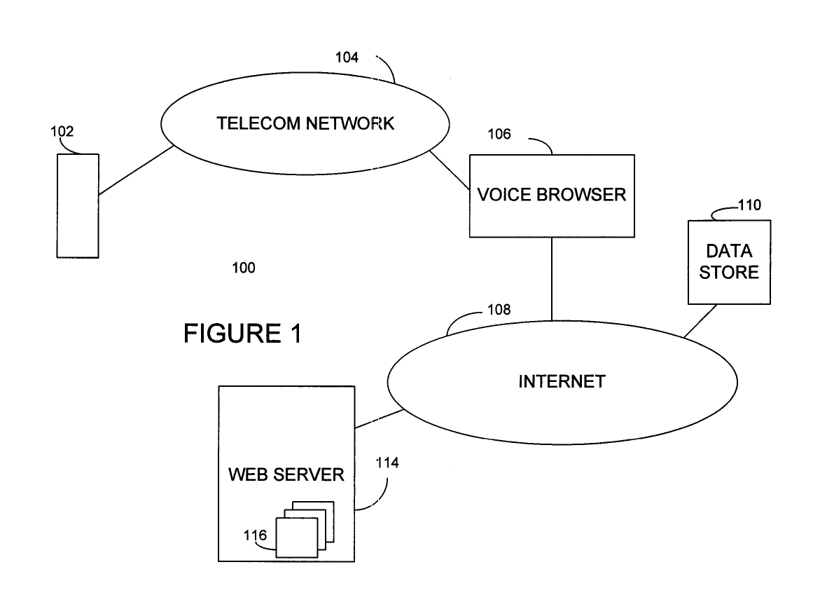

FIG. 1 is a block diagram of a voice browsing system according to one embodiment; and

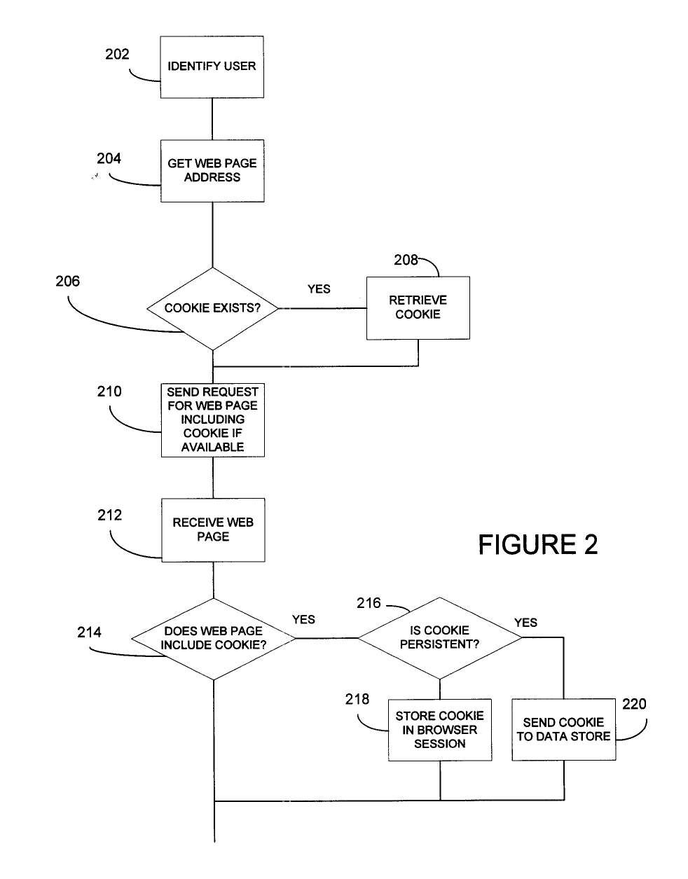

FIG. 2 is a flow diagram outlining example processing steps which may be taken by the voice browser of FIG. 1.

FIG. 1 is a block diagram of a voice browsing system 100 according to an embodiment of the present invention.

A user (not shown) of a user terminal 102, such as a conventional ‘black’ phone, mobile telephone, session initiation protocol (SIP) phone, or the like, places a call to a voice browser 106, via a an appropriate telecommunications network 104. The voice browser may be hosted, for example, on a suitable media platform (not shown) such as a Hewlett-Packard Open Call Media Platform (OCMP). For clarity only a single voice browser is shown, although it will be appreciated that a media platform may host multiple instances of a voice browser application thereby enabling multiple callers, each assigned a different instance, to browse the Internet at the same time.

The voice browser 106 enables the caller to browse a network, such as the Internet 108, via the user terminal 102 in a generally known manner. For example, the voice browser accepts voice or DTMF tone input via the user terminal 102 to enable the caller to browse web pages, such as web pages 1 16 stored on a web server 114. The voice browser 106 retrieves a web page from the web server 114, over the Internet 108, formats the information contained therein into appropriate speech or audio, and provides an output to the user terminal 102. A proxy server (not shown) may provide caching of web pages to help increase performance, in which case requested web pages may be supplied by the proxy if the web page has previously been cached.

When a new call is placed to the voice browser 106 a new browser session is established. As mentioned above, some web pages use session cookies which may be stored in a temporary data store associated with the browser session. When a browser session is terminated, for example when the user terminal 102 hangs up, the temporary data associated with the browser session, including all session cookies, is erased.

To enable the use of persistent cookies a persistent data store is required. In the present embodiment, a data store 110 is provided, use of which is described below in further detail, with reference to FIG. 2.

The data store 110 may be integral or external to the voice browser 106. The data store 110 may be available remotely, for example via the Internet, as shown in FIG. 1.

When a call is made to the voice browser 106 the voice browser identifies (step 202) the user terminal 102 using, for example, the network provided caller line identity (CLI) provided by the telecommunications network 104. Alternatively, the voice browser may identify the user of the user terminal 102 by requesting the caller to perform an identification step, such as the entering of an account identification and a password.

The voice browser 106 obtains (step 204) the universe resource identifier (URI) or other address identifier of a web page to be retrieved (hereinafter the requested URI). The requested URI may, for example, be preconfigured in the voice browser 106, or may be supplied by the user of the user terminal 102 in a known manner.

Prior to sending a HTTP request to the web server identified by the requested URI the voice browser 106 checks (step 206) to see whether there are any stored cookies associated with the requested URI. Initially the browser 106 checks the local storage associated with the browser session to determine whether any relevant session cookies are stored. If none are found the voice browser checks the data store 110. The data store 110, for example, may be provided as a database accessible through a HTTP interface on a suitable web server. In this case, a HTTP request may be sent to the data store 110 giving the obtained identity of the user or user terminal 102 along with the requested URI, using the example format shown below:
http://data store address?uid=userid&uri=requested uri

For example, assuming that the data store 110 has a URI of mycookiestore.hp.com, that the user identification number is 0123456789, and the requested URI is www.lemonde.fr/home.html, then the HTTP request sent by the browser may be:
http://mycookiestore.hp.com?userid=0123456789&uri=www.lemonde.fr/home.ht ml

The data store 110 provides persistent storage for cookies or other data in one or more user accounts. For example, in the case of a voice browser the data store 110 may have different persistent storage areas for each of the different callers to the voice browser 106. A user account in the data store 110 is identified by way of the user id sent by the browser, as mentioned above.

When the data store 110 receives a request from the voice browser 106, suitable control logic, such as a web server, analyses the request, and determines whether a cookie for the requested URI exists in the persistent storage area of the user account identified by the user id.

If no cookie corresponding to the requested URI is found in the user account a suitable message, such as HTTP “404 not found error” may be returned by the control logic indicating to the browser 106 that no relevant cookie is stored in the data store 110. If no relevant cookie is found, the browser 106 sends the HTTP request for the requested URI in the normal manner.

If a cookie is found, however, the cookie is returned to the browser (step 208), for example in the form of a text or HTML file. The cookie information is extracted by the browser and is sent (step 210), in addition to the HTTP request for the requested URI to the web server identified by the URI, thereby providing the cookie information to the web server 114 in the normal manner.

When the browser 106 receives a web page (step 212) the browser determines (step 214) whether there is a cookie associated with the received web page. Cookie information is typically included in the HTML code of a web page, or in a HTTP request or response, and if present the browser 106 extracts the cookie information and determines (step 216) whether the cookie is a session cookie or a persistent cookie. As previously mentioned, a persistent cookie has an expiry date set for a future date. If the cookie is a session cookie it is stored (step 218) in the storage area associated with the current browser session. If the cookie is a persistent cookie it is sent (step 220) to the data store 110 for storing. The sending of a persistent cookie to the data store 110 may be performed in any suitable manner, for example through use of a HTTP post procedure.

In an alternative embodiment session cookies may also be sent to the data store 110 for storing instead of storing them on the computing device hosting the voice browser 106.

Preferably the data store 110 periodically deletes any expired cookies. As a safeguard, however, it is preferable that the browser 106 checks the expiry date of any cookies retrieved from the data store 110, and if any cookie is determined as having expired it is not sent.

Although the above embodiments are described with reference to voice browsing, they are in no way limited thereto. It will be apparent that the above-described inventive concepts may be equally applied to more conventional Internet browsers, such as Mozilla, developed by The Mozilla Organization and Opera, developed by Opera Software ASA. In this case, the user of the browser preferably has an account on a suitable remote data store, such as the data store 110, and configures the browser with the address or appropriate access details of the data store, such as the data store 110, together with appropriate user account information, such as a user identification and password to enable cookies to be both stored and retrieved from the appropriate data store.

It can be conceived that a data store as described herein be supplied and managed by a third party company to which a user subscribes in order to have a user account and an amount of associated persistent storage. Such a third party company is preferably trusted by the user not to unnecessarily divulge the data stored in the user account. Alternatively, a user may have their own data store, for example hosted by an appropriate web server, in which all cookie information relating to the user is stored.

It will be appreciated that a browser is typically implemented by way of a computer program executing on a suitable host computing device. The functional steps outlined above may be suitably implemented using software modules or objects proving suitable control logic, processing logic, transmission logic, receiving logic and the like as required. Such a computer program may be provided in the form of an article of manufacture comprising computer readable storage storing a computer program for performing some or all of the steps outlined above.

As provided by the embodiments described herein, cookies need no longer to be associated uniquely with a particular browser or browser instance, but may be associated with an individual user account. This enables a user, for example, to use different browsers, and even different browsers on different computing devices, to access web pages whilst maintaining the continuity provided for by cookies.

An added benefit is that of improved security, especially when accessing web pages via public computing devices, such as those found in Internet cafes. Using the above-described techniques no persistent cookie information is stored locally on the browser, thereby enhancing the privacy of users by preventing information contained in cookies from being available to other users of the computing device.

Although reference is made herein to cookies, it will be appreciated that the inventive concepts described herein are not limited to the use of cookies. Those skilled in the art will appreciate that a cookie is one type of data package which 5 helps a service provider identifier a user, and which may be used for many different purposes. Use may equally be made of other networks other than the Internet, including other Internet protocol based and non-IP based networks.

1. A method of operating a browser, the browser operable for accessing electronic documents accessible via a document server, at least some of the electronic documents having associated therewith a data package intended for storage by the browser, comprising:
receiving from the document server an electronic document and a data package;
obtaining the identity of a data store; and
sending the data package to the identified data store for storage therein.

2. A method according to claim 1, wherein the data store is remote from the browser, the step of obtaining the identity of the data store further comprising obtaining the address of the data store.

3. A method according to claim 1, wherein the data store is an account-based data store, the step of obtaining further comprising obtaining account identification information associated with the data store.

4. A method according to claim 1, wherein the step of obtaining comprises obtaining the identity and account identification information from configuration data in the browser.

5. A method according to claim 3, wherein the browser is a voice browser accessible via a telecommunications network by way of a telephone call placed using a user terminal, the step of obtaining account identification information further comprising obtaining the subscriber number of the user terminal from information supplied by the telecommunications network.

6. A method according to claim 1, further comprising determining the expiry date of the received data package and where the determined expiry date is in the future, sending the data package to the identified data store, and otherwise storing the data package in a temporary data store associated with the browser.

7. A method according to claim 1, wherein the step of receiving a data package comprises receiving a data package in the form of a cookie.

8. A method of operating a browser, the browser operable for accessing electronic documents accessible via a document server, comprising:
acquiring an address of a requested electronic document to be retrieved;
obtaining the identity of a data store;
determining the presence in the identified data store of a data package associated with the requested electronic document, and where present retrieving the data package; and
sending a request to receive the requested electronic document and sending the retrieved data package, where present, with the request.

9. A method according to claim 8, wherein the data store is remote from the browser, the step of obtaining the identity of the data store further comprising obtaining the address of the data store.

10. A method according to claim 8, wherein the data store is an account-based data store, the step of obtaining further comprising obtaining account identification information associated with the data store.

11. A method according to claim 8, wherein the step of obtaining comprises obtaining the identity and account identification information from configuration data in the browser.

12. A method according to claim 10, wherein the browser is a voice browser accessible via a telecommunications network by way of a telephone call placed using a user terminal, the step of obtaining account identification information further comprising obtaining the subscriber number of the user terminal from information supplied by the telecommunications network.

13. A method according to claim 8, further comprising determining whether the retrieved data package has expired and wherein the step of sending the data package comprises only sending the data package where it is determined that the data package has not expired.

14. A method according to claim 8, wherein the steps of sending and retrieving a data package comprise sending and retrieving a data package in the form of a cookie.

15. A browser operable for accessing electronic documents accessible via a document server, at least some of the electronic documents having associated therewith a data package intended for storage by the browser, comprising:
receiver logic for receiving from the document server an electronic document and a data package;
control logic for obtaining the identity of a data store; and
transmission logic for sending the data package to the identified data store for storage therein.

16. A browser according to claim 15, wherein the data store is remote from the browser, the control logic being adapted to obtain the address of the data store.

17. A browser according to claim 15, wherein the data store is an account-based data store, the control logic being further adapted to obtain account identification information associated with the data store.

18. A browser according to claim 15, further comprising a local data storage medium for storing the identity of the data store and account identification information.

19. A browser according to claim 17, wherein the browser is a voice browser accessible via a telecommunications network by way of a telephone call placed using a user terminal, the control logic further adapted for obtaining the subscriber number of the user terminal from information supplied by the telecommunications network.

20. A browser according to claim 15, further comprising processing logic for determining the expiry date of the received data package, the transmission logic being adapted for sending the data package to the identified data store where it is determined that the data package has not expired, and otherwise for storing the data package in a temporary data store associated with the browser.

21. A browser according to claim 15, adapted for use with data packages in the form of cookies.

22. A browser operable for accessing electronic documents accessible via a document server, comprising:
processing logic for obtaining an address of a requested electronic document to be retrieved;
control logic for obtaining the identity of a data store;
processing means for determining the presence in the identified data store of a data package associated with the requested electronic document, and where present for retrieving the data package; and
transmission logic for sending a request to receive the requested electronic document and, where present, for sending the retrieved data package with the request.

23. A browser according to claim 22, wherein the data store is remote from the browser, the processing logic adapted for obtaining the address of the data store.

24. A browser according to claim 22, wherein the data store is an account-based data store, the processing logic adapted for obtaining account identification information associated with the data store.

25. A browser according to claim 22, further comprising a local storage medium for storing the identity of the data store and account identification information.

26. A browser according to claim 24, wherein the browser is a voice browser accessible via a telecommunications network by way of a telephone call placed using a user terminal, the control logic adapted for obtaining the subscriber number of the user terminal from information supplied by the telecommunications network.

27. A browser according to any claims 22, further processing logic for determining whether the retrieved data package has expired and wherein the transmission logic is further adapted for only sending the data package where it is determined that the data package has not expired.

28. A browser according to any of claims 22, adapted for use with data packages in the form of cookies.

29. A computer program comprising computer program code means to implement a system or method as claimed in claim 1.

30. A computer program product comprising computer readable storage storing a computer program as claimed in claim 29.
